(19) United States
(12) Patent Application Publication
(10) Pub. No.: US 2024/0025741 A1
(43) Pub. Date: Jan. 25, 2024

(54) BORON NITRIDE PARTICLES, RESIN COMPOSITION, AND METHOD FOR PRODUCING RESIN COMPOSITION

(71) Applicant: Denka Company Limited, Chuo-ku, Tokyo (JP)

(72) Inventors: Yusuke SASAKI, Chuo-ku, Tokyo (JP); Kenji MIYATA, Chuo-ku, Tokyo (JP); Michiharu NAKASHIMA, Chuo-ku, Tokyo (JP)

(73) Assignee: Denka Company Limited, Chuo-ku, Tokyo (JP)

(21) Appl. No.: 18/041,934

(22) PCT Filed: Aug. 19, 2021
(86) PCT No.: PCT/JP2021/030450

§ 371 Date: Feb. 16, 2023

(30) Foreign Application Priority Data
Aug. 20, 2020 (JP) 2020-139482

(51) Int. Cl. C01B 21/064; C08K 7/00; C08J 3/20; C09K 5/14

(52) U.S. Cl. CPC C01B 21/064; C08K 7/00; C08J 3/203; C09K 5/14; C01P 2002/72; C01P 2004/03; C01P 2006/32; C08K 2201/001; C08K 2201/004

(57) ABSTRACT

A boron nitride particle having a shape in which a diameter gradually increases from one end toward the other end. A boron nitride particle including a plurality of portions each having a shape in which a diameter gradually increases from one end toward the other end, in which the plurality of portions bond to each other on the other end side.

### TECHNICAL FIELD

The present disclosure relates to boron nitride particles, a resin composition, and a method for producing a resin composition.

### BACKGROUND ART

Boron nitride has lubricity, high thermal conductivity and insulating properties and is in use for a variety of uses such as solid lubricating materials, releasing materials, cosmetic raw materials, heat dissipation materials and sintered products having heat resistance and insulating properties.

For example, as a hexagonal boron nitride powder that is loaded into a resin to be capable of imparting high thermal conductivity and high dielectric strength to a resin composition to be obtained, Patent Literature 1 discloses a hexagonal boron nitride powder in which an agglomerated particle composed of the primary particles of hexagonal boron nitride is contained, the BET specific surface area is 0.7 to 1.3 m²/g and an oil absorption that is measured based on JIS K 5101-13-1 is g/100 g or less.

### CITATION LIST

### Patent Literature

[Patent Literature 1] Japanese Unexamined Patent Publication No. 2016-160134

### SUMMARY OF INVENTION

### Technical Problem

A main objective of the present invention is to provide a new boron nitride particle.

### Solution to Problem

One aspect of the present invention is a boron nitride particle having a shape in which a diameter gradually increases from one end toward the other end.

A length in a direction from the one end toward the other end may be 80 μm or longer.

Another aspect of the present invention is a boron nitride particle including a plurality of portions each having a shape in which a diameter gradually increases from one end toward the other end, in which the plurality of portions bond to each other on the other end side.

A length in a direction from the one end toward the other end in the plurality of portions may be 80 μm or longer.

Still another aspect of the present invention is a resin composition containing the boron nitride particle and a resin.

Far still another aspect of the present invention is a method for producing a resin composition, including a step of preparing the boron nitride particle and a step of mixing the boron nitride particle with a resin. This method for producing a resin composition may further include a step of pulverizing the boron nitride particle.

### Advantageous Effects of Invention

According to one aspect of the present invention, it is possible to provide a new boron nitride particle.

### BRIEF DESCRIPTION OF DRAWINGS

FIG. 1 is a graph of X-ray diffraction measurement results of boron nitride particles of Example 1.

FIG. 2 is a SEM image of the boron nitride particles of Example 1.

FIG. 3 is a SEM image of boron nitride particles of Example 2.

FIG. 4 is a SEM image of boron nitride particles of Example 3.

### DESCRIPTION OF EMBODIMENTS

Hereinafter, an embodiment of the present invention will be described in detail. One embodiment of the present invention is a boron nitride particle having a shape in which a diameter gradually increases from one end toward the other end (this boron nitride particle will be referred to as boron nitride particle A).

In the present specification, a direction from one end toward the other end of the boron nitride particle A is regarded as an axial direction, and a direction perpendicular to the axial direction is regarded as a radial direction. In addition, in the present specification, the diameter of the boron nitride particle A means the size of the boron nitride particle in the radial direction.

While a conventional boron nitride particle has a flaky shape, a spherical shape or an irregular shape, in the boron nitride particle A according to one embodiment, the diameter gradually increases from one end toward the other end of the boron nitride particle. Therefore, the center of gravity is located on the other end side in the axial direction of the boron nitride particle A, and thus it is considered that, when used in a heat dissipation material (heat dissipation sheet), the boron nitride particle A is likely to stand in the thickness direction of the heat dissipation material with the one end side (a side where the diameter is relatively small) positioned up and the other end side (a side where the diameter is relatively large) positioned down. Therefore, this boron nitride particle A can be suitably used for heat dissipation materials. As the use of the boron nitride particle A, the heat dissipation material has been exemplified, but this boron nitride particle A can be used in a variety of uses without being limited to heat dissipation materials.

The fact that the boron nitride particle A has the above-described shape can be confirmed from the fact that, in an observation image of the boron nitride particle A observed with SEM, when the diameters of the boron nitride particle A in 10 sites at equal intervals in the axial direction of the boron nitride particle A are defined as A₁, A₂, . . . , A₁₀ in order from one end toward the other end of the boron nitride particle A (the diameter of the boron nitride particle at the one end is A₁ and the diameter at the other end is A₁₀), A₁, A₂, . . . , A₁₀ gradually increase. The diameter Aₙ (n is an integer of 2 to 10) of the boron nitride particle A preferably becomes larger than the diameter Aₙ₋₁ in all of the nine sites of A₂ to A₁₀, but Aₙ may become larger than the diameter Aₙ₋₁ in 8 sites of 9 sites. The diameter of the boron nitride particle A may be measured by importing the SEM image into image analyzing software (for example, “Mac-view” manufactured by Mountech Co., Ltd.).

As the diameter A₁₀ of the boron nitride particle A becomes larger relative to the diameter A₁ of the boron nitride particle A, the center of gravity in the axial direction of the boron nitride particle A is positioned closer to the other end side. Therefore, for example, when a heat dissipation material has been produced by mixing the boron nitride particle A with a resin, it is considered that the boron nitride particle A is more likely to stand in the thickness direction of the heat dissipation material and thus the heat dissipation material has excellent thermal conductivity. The diameter A₁₀ of the boron nitride particle A may be 1.2 times or more, 1.4 times or more, 1.6 times or more, 1.8 times or more or twice or more and may be 10 times or less, 8 times or less or 6 times or less the diameter A₁ of the boron nitride particle A.

The maximum length in the axial direction of the boron nitride particle A may be 80 μm or longer, 100 μm or longer, 125 μm or longer, 150 μm or longer, 175 μm or longer, 200 μm or longer, 225 μm or longer, 250 μm or longer, 300 μm or longer or 350 μm or longer and may be 500 μm or shorter. The maximum length of the boron nitride particle A may be measured by importing the SEM image into image analyzing software (for example, “Mac-view” manufactured by Mountech Co., Ltd.).

In a case where the length in the axial direction of the boron nitride particle A is large, it is considered that, for example, when the boron nitride particle A has stood in the thickness direction of the heat dissipation material as described above, the number of the boron nitride particles that are lined up in the thickness direction of the heat dissipation material becomes small, and heat transfer loss between the boron nitride particles becomes small. Therefore, it is considered that the heat dissipation material has excellent thermal conductivity.

The maximum value of the diameter of the boron nitride particle A may be 50 μm or longer, 80 μm or longer, 100 μm or longer, 125 μm or longer, 150 μm or longer, 175 μm or longer, 200 μm or longer, 225 μm or longer, 250 μm or longer, 300 μm or longer or 350 μm or longer and may be 500 μm or shorter.

The minimum value of the diameter of the boron nitride particle A may be 1 μm or longer, 2 μm or longer, 5 μm or longer, 10 μm or longer, 15 μm or longer or 20 nm or longer and may be 100 μm or shorter, 80 μm or shorter, 70 μm or shorter, 60 μm or shorter, 50 μm or shorter or 40 μm or shorter.

The average value of the diameter of the boron nitride particle A (the average value of the diameters A₁ to A₁₀) may be 10 μm or longer, μm or longer, 20 μm or longer, 25 μm or longer, 30 μm or longer, 40 μm or longer or 50 μm or longer and may be 200 nm or shorter, 150 μm or shorter, 100 μm or shorter, 80 μm or shorter, 70 μm or shorter or 60 μm or shorter.

The aspect ratio of the boron nitride particle A may be 1.1 or more, 1.2 or more, 1.3 or more, 1.4 or more, 1.5 or more, 2.0 or more, 3.0 or more, 5.0 or more or 7.0 or more and may be 12.0 or less, 10.0 or less, 9.5 or less, 9.0 or less or 8.0 or less. The aspect ratio of the boron nitride particle A is defined as the ratio (L₁/L₂) of the maximum length (L₁) in the axial direction of the boron nitride particle A to the average length (L₂) of the diameters A₁ to A₁₀ of the boron nitride particle A.

As the aspect ratio of the boron nitride particle A increases, the shape of the boron nitride particle A becomes longer and thinner. Therefore, when a heat dissipation material has been produced by, for example, mixing the boron nitride particle A with a resin, the boron nitride particle A is likely to overlap another different boron nitride particle. Furthermore, when the boron nitride particle A overlaps another boron nitride particle, it is considered that the boron nitride particle A having a long and thin shape overlaps another so as to be inclined. Therefore, it is considered that the number of the boron nitride particles that are lined up in the thickness direction of the heat dissipation material becomes small, and heat transfer loss between the boron nitride particles becomes small, and thus the heat dissipation material has excellent thermal conductivity.

The boron nitride particle A may be solid or hollow. In a case where the boron nitride particle A is hollow, the boron nitride particle A may have a shell part formed of boron nitride and a hollow part surrounded by the shell part. The hollow part may extend in the axial direction of the boron nitride particle A or may have a shape that is an approximately similar shape to the external appearance shape of the boron nitride particle A. In this case, the boron nitride particle A can also be said as a tubular boron nitride particle in which the diameter gradually increases from one end toward the other end.

One or both of one end and the other end of the boron nitride particle A may be an open end. The open end may communicate with the above-described hollow part. In a case where the boron nitride particle A is hollow, and at least one of one end and the other end of the boron nitride particle A is an open end, for example, when the boron nitride particle A is mixed with a resin and used as a heat dissipation material, the resin that weighs less than the boron nitride particle A is loaded into the hollow part, whereby the weight reduction of the heat dissipation material can be expected while the heat dissipation material has thermal conductivity.

In another embodiment, a boron nitride particle may be a boron nitride particle including a plurality of portions each having a shape in which the diameter gradually increases from one end toward the other end, in which the plurality of portions bond to each other on the other end side (this boron nitride particle will be referred to as boron nitride particle B).

In the boron nitride particle B, a direction from one end toward the other end of each portion is regarded as an axial direction, and a direction perpendicular to the axial direction is regarded as a radial direction. The fact that each portion of the boron nitride particle B has the above-described shape may be the same method as the above-described method for confirming the shape of the boron nitride particle A. The maximum length and the like in the axial direction of each portion of the boron nitride particle B may be the same as the ranges described as the above-described maximum length and the like in the axial direction of the boron nitride particle A.

While a conventional boron nitride particle has a flaky shape, a spherical shape or an irregular shape, the boron nitride particle B according to one embodiment includes a plurality of portions each having a shape in which the diameter gradually increases from one end toward the other end, and the plurality of portions bond to each other on the other end side. Therefore, the center of gravity of the boron nitride particle B is located on the other end side (a side where the plurality of portions bond to each other), and thus it is considered that, when used in a heat dissipation material (heat dissipation sheet), the boron nitride particle B is likely to stand in the thickness direction of the heat dissipation material with the other end side positioned down. Therefore, this boron nitride particle B can also be suitably used for heat dissipation materials. This boron nitride particle B can also be used in a variety of uses without being limited to heat dissipation materials.

The boron nitride particle B may be solid or hollow. In a case where the boron nitride particle B is hollow, the boron nitride particle B may have a shell part formed of boron nitride and a hollow part surrounded by the shell part. The hollow part may extend in the axial direction at one portion of the plurality of portions of the boron nitride particle B or may extend in the axial direction at two or more portions of the plurality of portions. The hollow part may have a shape that is an approximately similar shape to the external appearance shape of each portion of the boron nitride particle B. In a case where the hollow part extends in the axial direction at a plurality of portions of the boron nitride particle B, the boron nitride particle B can also be said as a boron nitride particle including a plurality of portions each having a tubular shape in which the diameter gradually increases from one end toward the other end, in which the plurality of portions bond to each other on the other end side.

In each of the plurality of portions of the boron nitride particle B, one or both of one end and the other end may be an open end. The open end may communicate with the above-described hollow part. In a case where the boron nitride particle B is hollow, and at least one of one end and the other end of the boron nitride particle B is an open end, for example, when the boron nitride particle B is mixed with a resin and used as a heat dissipation material, the resin that weighs less than the boron nitride particle B is loaded into the hollow part, whereby the weight reduction of the heat dissipation material can be expected while the heat dissipation material has thermal conductivity.

The above-described boron nitride particle (the boron nitride particle A and the boron nitride particle B) may be substantially composed of boron nitride alone. The fact that the above-described boron nitride particle is substantially composed of boron nitride alone can be confirmed from the fact that only a peak derived from boron nitride is detected in X-ray diffraction measurement.

Subsequently, a method for producing the above-described boron nitride particle (the boron nitride particle A and the boron nitride particle B) will be described below. The above-described boron nitride particle can be produced by method for producing a boron nitride particle including a step of disposing a mixture and a base material in a container formed of a carbon material, in which the mixture includes boron carbide and boric acid, and the base material is formed of a carbon material (disposition step) and a step of generating a boron nitride particle on the base material by performing heating and pressurization with a nitrogen atmosphere formed in the container (generation step). Another embodiment of the present invention is such a method for producing a boron nitride particle.

The container formed of a carbon material is a container capable of accommodating the mixture and the base material. The container may be, for example, a carbon crucible. The container is preferably a container airtightness of which can be enhanced by covering an open part with a lid. In the disposition step, for example, the mixture may be disposed on a bottom part of the container, and the base material may be disposed so as to be fixed to a side wall surface in the container or to the inside of the lid. The base material formed of a carbon material may have, for example, a sheet shape, a plate shape or a rod shape. The base material formed of a carbon material may be, for example, a carbon sheet (graphite sheet), a carbon plate or a carbon rod.

The diameter of the above-described boron nitride particle at one end can be adjusted by adjusting the distance between the mixture and the surface of the base material. In a case where the distance between the mixture and the surface of the base material is far (for example, 2.0 cm or longer), there is a tendency that the diameter of the boron nitride particle at one end becomes equal to or shorter than the half of the diameter at the other end.

The boron carbide in the mixture may be, for example, in a powder form (boron carbide powder). The boron nitride in the mixture may be, for example, in a powder form (boron nitride powder). The boric acid in the mixture may be, for example, in a powder form (boric acid powder). The mixture can be obtained by, for example, mixing a boron carbide powder, a boron nitride powder and a boric acid powder by a well-known method.

The boron carbide powder can be produced by a well-known production method. Examples of the method for producing the boron carbide powder include a method in which boric acid and acetylene black are mixed together and then heated at 1800° C. to 2400° C. for one to 10 hours in an inert gas (for example, nitrogen gas) atmosphere, thereby obtaining a massive boron carbide particle. The boron carbide powder can be obtained by appropriately performing pulverization, shieving, washing, impurity removal, drying and the like on the massive boron carbide particle obtained by this method.

The average particle diameter of the boron carbide powder can be adjusted by adjusting the pulverization time of the massive boron carbide particle. The average particle diameter of the boron carbide powder may be 5 μm or more, 7 μm or more or 10 μm or more and may be 100 μm or less, 90 μm or less, 80 μm or less or 70 μm or less. The average particle diameter of the boron carbide powder can be measured by a laser diffraction and scattering method.

The boron nitride powder can be produced by a well-known method. As a method for producing the boron nitride powder, the boron nitride powder can be obtained by, for example, mixing boric acid or boric oxide, melamine and water, removing water from a mixture thereof by a method such as filtration, centrifugation or drying and then firing the mixture in a non-oxidative gas atmosphere.

The average particle diameter of the boron nitride powder may be 5 μm or longer, 7 μm or longer or 10 μm or longer and may be 100 μm or shorter, 90 μm or shorter, 80 μm or shorter or 70 μm or shorter. The average particle diameter of the boron nitride powder can be measured by a laser diffraction and scattering method.

The mixing fractions between the boron carbide, the boron nitride and the boric acid can be appropriately selected. From the viewpoint of suppressing a change in the distance between the mixture and the surface of the base material due to the expansion of boron carbide, the content of the boron nitride in the mixture is, with respect to 100 parts by mass of the boron carbide, preferably 50 parts by mass or more, more preferably 70 parts by mass or more and still more preferably 80 parts by mass or more and may be 150 parts by mass or less, 120 parts by mass or less or 100 parts by mass or less. From the viewpoint of the boron nitride particle being likely to become large, the content of the boric acid in the mixture is, with respect to 100 parts by mass of the boron carbide, preferably 2 parts by mass or more, more preferably 5 parts by mass or more and still more preferably 8 parts by mass or more and may be 100 parts by mass or less, 90 parts by mass or less or 80 parts by mass or less. When the content of the boric acid in the mixture is 10 mass % or more based on the total mass of the mixture, the boron nitride particle B is easily generated.

The mixture containing boron carbide, boron nitride and boric acid may further contain other components. Examples of the other components include silicon carbide, carbon, iron oxide and the like. When the mixture containing boron carbide, boron nitride and boric acid further contains silicon carbide, it becomes easy to obtain a boron nitride particle having no open end.

In the container, for example, a nitrogen atmosphere containing vol % or more of nitrogen gas has been formed. The content of the nitrogen gas in the nitrogen atmosphere is preferably 95 vol % or more and more preferably 99.9 vol % or more and may be substantially 100 vol %. In the nitrogen atmosphere, not only the nitrogen gas but also ammonia gas or the like may be contained.

From the viewpoint of the boron nitride particle being likely to become large, the heating temperature is preferably 1450° C. or higher, more preferably 1600° C. or higher and still more preferably 1800° C. or higher. The heating temperature may be 2400° C. or lower, 2300° C. or lower or 2200° C. or lower.

From the viewpoint of the boron nitride particle being likely to become large, the pressure at the time of the pressurization is preferably 0.3 MPa or higher and more preferably 0.6 MPa or higher. The pressure at the time of the pressurization may be 1.0 MPa or lower or MPa or lower.

From the viewpoint of the boron nitride particle being likely to become large, the time for performing the heating and the pressurization is preferably three hours or longer and more preferably five hours or longer. The time for performing the heating and the pressurization may be 40 hours or shorter or 30 hours or shorter.

According to this production method, the above-described boron nitride particles are generated on the base material formed of a carbon material. Therefore, boron nitride particles can be obtained by collecting the boron nitride particles on the base material. The fact that the particles generated on the base material are boron nitride particles can be confirmed from the fact that a peak derived from boron nitride is detected when some of the particles are collected from the base material and X-ray diffraction measurement is performed on the collected particles.

A step of classifying the boron nitride particles obtained as described above so that only a boron nitride particle having a maximum length in a specific range can be obtained (classification step) may also be performed.

The boron nitride particle obtained as described above can be mixed with a resin and used as a resin composition. That is, still another embodiment of the present invention is a resin composition containing the boron nitride particle and a resin.

Examples of the resin include an epoxy resin, a silicone resin, silicone rubber, an acrylic resin, a phenolic resin, a melamine resin, a urea resin, an unsaturated polyester, a fluorine resin, a polyimide, a polyamide-imide, polyetherimide, polybutylene terephthalate, polyethylene terephthalate, polyphenylene ether, polyphenylene sulfide, wholly aromatic polyester, polysulfone, a liquid crystal polymer, polyethersulfone, polycarbonate, a maleimide-modified resin, an ABS (acrylonitrile-butadiene-styrene) resin, an AAS (acrylonitrile-acrylic rubber styrene) resin, an AES (acrylonitrile ethylene propylene diene rubber styrene) resin and the like.

In the case of using the resin composition as a heat dissipation material, from the viewpoint of improving the thermal conductivity of the heat dissipation material and easily obtaining excellent heat dissipation performance, the content of the boron nitride particles may be 15 vol % or more, 20 vol % or more, 30 vol % or more, 40 vol % or more, 50 vol % or more or 60 vol % or more based on the total volume of the resin composition. From the viewpoint of suppressing the generation of voids at the time of molding the resin composition into a sheet-like heat dissipation material and being capable of suppressing the degradation of the insulating properties and mechanical strength of the sheet-like heat dissipation material, the content of the boron nitride particles may be 85 vol % or less, 80 vol % or less, 70 vol % or less, 60 vol % or less, 50 vol % or less or 40 vol % or less based on the total volume of the resin composition.

The content of the resin may be appropriately adjusted depending on the use, required characteristics or the like of the resin composition. The content of the resin may be, for example, 15 vol % or more, 20 vol % or more, 30 vol % or more, 40 vol % or more, 50 vol % or more or 60 vol % or more and may be 85 vol % or less, 70 vol % or less, 60 vol % or less, 50 vol % or less or 40 vol % or less based on the total volume of the resin composition.

The resin composition may further contain a curing agent that cures the resin. The curing agent is appropriately selected depending on the kind of the resin. Examples of the curing agent that can be used together with an epoxy resin include phenol novolac compounds, acid anhydrides, amino compounds, imidazole compounds and the like. The content of the curing agent may be, for example, 0.5 parts by mass or more or 1.0 part by mass or more and may be 15 parts by mass or less or 10 parts by mass or less with respect to 100 parts by mass of the resin.

The resin composition may further contain other components. The other components may be a curing accelerator (curing catalyst), a coupling agent, a wetting and dispersing additive, a surface conditioner and the like.

Examples of the curing accelerator (curing catalyst) include phosphorus-based curing accelerators such as tetraphenylphosphonium tetraphenylborate and triphenylphosphate, imidazole-based curing accelerators such as 2-phenyl-4,5-dihydroxymethylimidazole, amine-based curing accelerators such as boron trifluoride monoethylamine and the like.

Examples of the coupling agent include a silane-base coupling agent, a titanate-based coupling agent, an aluminate-based coupling agent and the like. Examples of a chemical bonding group that is contained in these coupling agents include a vinyl group, an epoxy group, an amino group, a methacrylic group, a mercapto group and the like.

Examples of the wetting and dispersing additive include phosphate ester salt, carboxylate ester, polyester, acrylic copolymers, block copolymers and the like.

Examples of the surface conditioner include an acrylic surface conditioner, a silicone-based surface conditioner, a vinyl-based surface conditioner, a fluorine-based surface conditioner and the like.

The resin composition can be produced by, for example, a method for producing a resin composition including a step of preparing the boron nitride particle according to one embodiment (preparation step) and a step of mixing the boron nitride particles with a resin (mixing step). Far still another embodiment of the present invention is such a method for producing a resin composition. In the mixing step, in addition to the boron nitride particle and the resin, the above-described curing agent or the other components may be further mixed therewith.

The method for producing a resin composition according to one embodiment may further include a step of pulverizing the boron nitride particle (pulverization step). The pulverization step may be performed between the preparation step and the mixing step or may be performed at the same time as the mixing step (the boron nitride particle may be pulverized at the same time as the mixing of the boron nitride particle with the resin).

The resin composition can be used as, for example, a heat dissipation material. The heat dissipation material can be produced by, for example, curing the resin composition. A method for curing the resin composition is appropriately selected depending on the kind of the resin (and the curing agent that is used as necessary) contained in the resin composition. For example, in a case where the resin is an epoxy resin and the above-described curing agent is used together, the resin can be cured by heating.

### EXAMPLES

Hereinafter, the present invention will be more specifically described using examples. However, the present invention is not limited to the following examples.

### Example 1

Massive boron carbide particles were pulverized with a pulverizer, and a boron carbide powder having an average particle diameter of 10 μm was obtained. 50 Parts by mass of the obtained boron carbide powder, 45 parts by mass of a boron nitride powder (manufactured by Denka Company Limited, GP grade) and 9 parts by mass of boric acid were mixed together, the obtained mixture was loaded into a carbon crucible, an open part of the carbon crucible was covered with a carbon sheet (manufactured by NeoGraf Solutions), and the carbon sheet was sandwiched by a lid of the carbon crucible and the carbon crucible to fix the carbon sheet. The distance between the mixture and the carbon sheet was 2.0 cm. The carbon crucible covered with the lid was heated in a nitrogen gas atmosphere under conditions of 2000° C. and 0.85 MPa for 10 hours in a resistance heating furnace, whereby particles were generated on the carbon sheet.

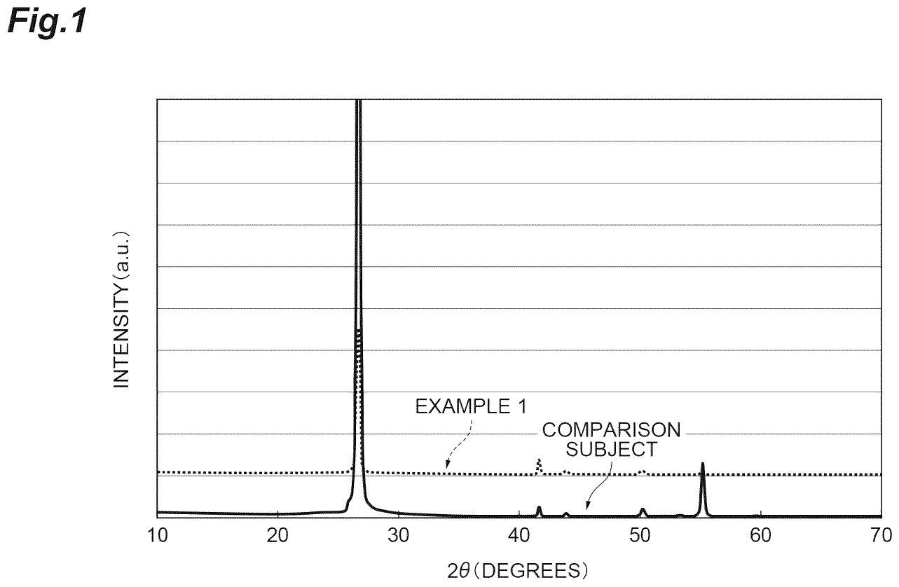

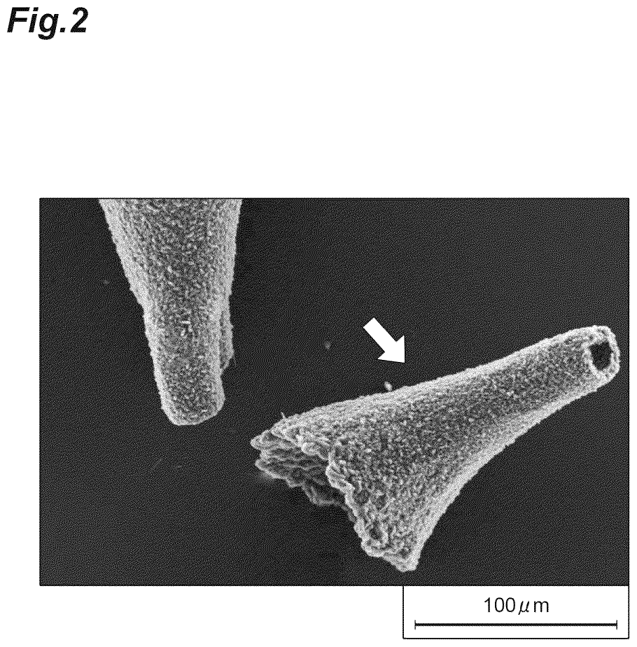

Some of the particles generated on the carbon sheet were collected and measured by X-ray diffraction using an X-ray diffractometer (manufactured by Rigaku Corporation, “ULTIMA-IV”). This X-ray diffraction measurement result and the X-ray diffraction measurement result of a boron nitride powder (GP grade) manufactured by Denka Company Limited as a comparison subject are each shown in FIG. 1. As is clear from FIG. 1, only a peak derived from boron nitride was detected, and it was possible to confirm that boron nitride particles were generated. A SEM image of the obtained boron nitride particles is shown in FIG. 2. One of the obtained boron nitride particles (a boron nitride particle indicated by an arrow in FIG. 2) had a shape in which the diameter gradually increased from one end toward the other end. The boron nitride particle had a maximum length in the axial direction of 184 μm and a maximum value of the diameter of 108 μm. When the diameters of the boron nitride particle in 10 sites at equal intervals in the axial direction of the boron nitride particle were defined as A₁, A₂, . . . , A₁₀ in order from one end toward the other end of the boron nitride particle (the diameter of the boron nitride particle at the one end was A₁ and the diameter at the other end was A₁₀), A₁ was 33 μm, A₁₀ was 108 μm, and the average value of A₁ to A₁₀ was 63 μm.

### Example 2

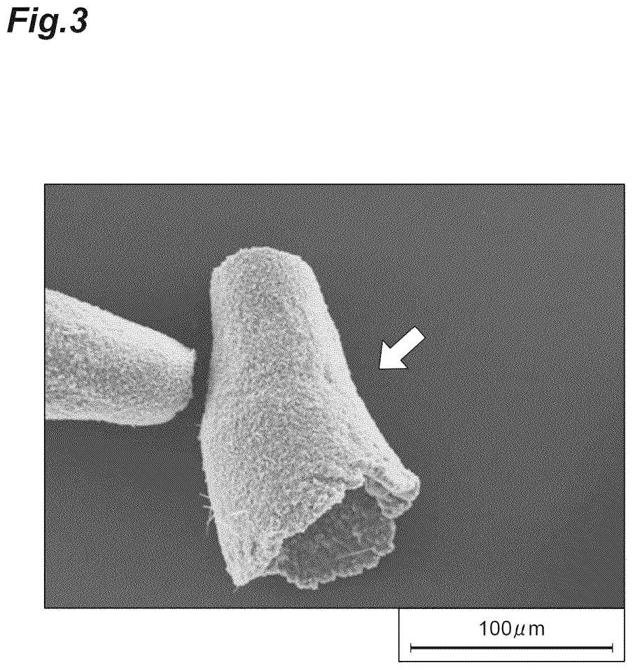

Particles were generated on a carbon sheet in the same manner as in Example 1 except that the mixture was obtained by changing the boron nitride powder to a boron nitride powder of a SGP grade manufactured by Denka Company Limited and the distance between the obtained mixture and the carbon sheet was changed to 1.5 cm. As a result of collecting some of the particles generated on the carbon sheet and measuring the particles by X-ray diffraction, only a peak derived from boron nitride was detected, and it was possible to confirm that boron nitride particles were generated. A SEM image of the obtained boron nitride particles is shown in FIG. 3. One of the obtained boron nitride particles (a boron nitride particle indicated by an arrow in FIG. 3) had a shape in which the diameter gradually increased from one end toward the other end. The boron nitride particle had a maximum length in the axial direction of 153 μm and a maximum value of the diameter of 106 μm. When the diameters of the boron nitride particle in 10 sites at equal intervals in the axial direction of the boron nitride particle were defined as A₁, A₂, . . . , A₁₀ in order from one end toward the other end of the boron nitride particle (the diameter of the boron nitride particle at the one end was A₁ and the diameter at the other end was A₁₀), A₁ was 51 μm, A₁₀ was 106 μm, and the average value of A₁ to A₁₀ was 80 μm.

### Example 3

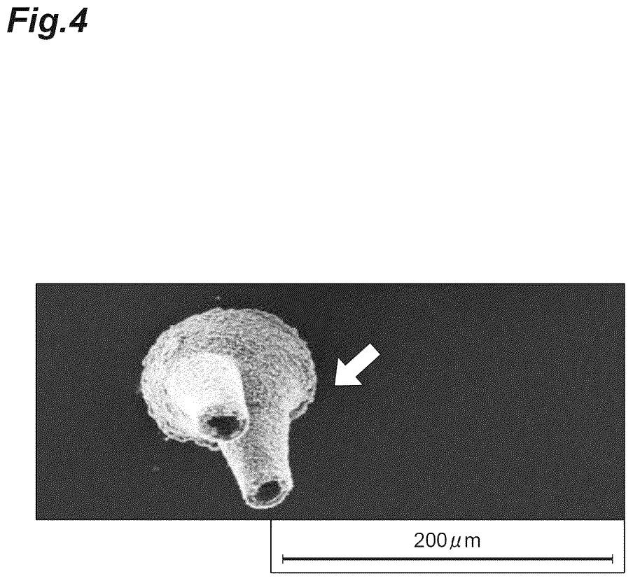

Particles were generated on a carbon sheet in the same manner as in Example 1 except that the mixture was obtained by changing the amount of boric acid blended to 12 parts by mass. As a result of collecting some of the particles generated on the carbon sheet and measuring the particles by X-ray diffraction, only a peak derived from boron nitride was detected, and it was possible to confine that boron nitride particles were generated. A SEM image of the obtained boron nitride particles is shown in FIG. 4. One of the obtained boron nitride particles (a boron nitride particle indicated by an arrow in FIG. 4) had a plurality of portions each having a shape in which the diameter gradually increased from one end toward the other end, and the plurality of portions bonded to each other on the other end side.

1. A boron nitride particle having a shape in which a diameter gradually increases from one end toward the other end.

2. The boron nitride particle according to claim 1,
wherein a length in a direction from the one end toward the other end is 80 μm or longer.

3. A boron nitride particle comprising a plurality of portions each having a shape in which a diameter gradually increases from one end toward the other end,
wherein the plurality of portions bond to each other on the other end side.

4. The boron nitride particle according to claim 3,
wherein a length in a direction from the one end toward the other end in the plurality of portions is 80 μm or longer.

5. A resin composition comprising:
the boron nitride particle according to claim 1; and
a resin.

6. A method for producing a resin composition, comprising:
a step of preparing the boron nitride particle according to claim 1; and
a step of mixing the boron nitride particle with a resin.

7. The method for producing a resin composition according to claim 6, further comprising:
a step of pulverizing the boron nitride particle.

8. A resin composition comprising:
the boron nitride particle according to claim 3 and
a resin.

9. A method for producing a resin composition, comprising:
a step of preparing the boron nitride particle according to claim 3 and
a step of mixing the boron nitride particle with a resin.

10. The method for producing a resin composition according to claim 9, further comprising:
a step of pulverizing the boron nitride particle.
